(19) United States
(12) Patent Application Publication
(10) Pub. No.: US 2024/0366980 A1
(43) Pub. Date: Nov. 7, 2024

(54) WATER CURTAIN NOZZLE

(71) Applicant: American Fire Equipment, Inc., Bronson, IA (US)

(72) Inventor: Craig D. Hillinger, Bronson, IA (US)

(21) Appl. No.: 18/652,989

(22) Filed: May 2, 2024

Related U.S. Application Data
(60) Provisional application No. 63/499,805, filed on May 3, 2023.

(51) Int. Cl. A62C 31/00

(52) U.S. Cl. CPC A62C 31/005

(57) ABSTRACT

A water curtain nozzle is provided. A cylindrical body has an open end configured for attachment to a firehose and a closed end. One or more rows of apertures extends through the cylindrical body generally around half of the diameter of the cylindrical body, and said one or more rows of apertures being oriented to expel fluid from the cylindrical body perpendicular to a longitudinal axis of the cylindrical body. The disclosed water curtain nozzle expels fluid in a generally semicircular dispersion pattern that forms a water curtain that can be placed between a burning structure and neighboring structures to prevent fire from spreading to the neighboring structures.

### CROSS-REFERENCE TO RELATED APPLICATIONS

This patent application claims priority to U.S. Provisional Patent Application No. 63/499,805 filed on May 3, 2023, the entirety of which is incorporated herein fully by reference.

### FIELD OF THE DISCLOSURE

The disclosure relates to nozzle devices and more particularly to a new nozzle device for creating a water curtain that prevents a fire from spreading to surrounding structures.

### BACKGROUND OF THE DISCLOSURE

When a structure is on fire, the fire can easily spread to surrounding structures. Current fire suppression nozzles are designed to direct water onto a burning structure to extinguish the flames but are incapable of creating an effective barrier to prevent the fire from spreading to neighboring structures. Thus, a water curtain nozzle that can create a water curtain that prevents fire from spreading to adjacent structures is desired.

### BRIEF SUMMARY OF THE DISCLOSURE

The disclosure relates to a water curtain nozzle. In one embodiment, a water curtain nozzle comprises a cylindrical body having an open end configured to be attached to a fire hose and a closed end opposite the open end. The cylindrical body extends between the open end and the closed end. One or more rows of closely spaced apertures extends through the cylindrical body to expel fluid from the nozzle in a roughly semi-circular dispersal pattern to create a generally uniform curtain or wall of water that prevents fire from spreading from a burning structure to another structure. An optional base and extension may be used with the water curtain nozzle to provide additional reach and stability.

### BRIEF DESCRIPTION OF THE DRAWING(S)

FIG. 1 depicts a water curtain nozzle according to one embodiment.

FIG. 2 depicts a water curtain nozzle according to one embodiment.

FIG. 3 depicts a base and extension for use with a water curtain nozzle according to one embodiment.

FIG. 4 depicts a base and extension for use with a water curtain nozzle according to one embodiment.

FIG. 5 depicts a base and extension for use with a water curtain nozzle according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description and are not intended to be used as limitations. Accordingly, orientation of an object or a combination of objects may change without departing from the scope of the disclosure.

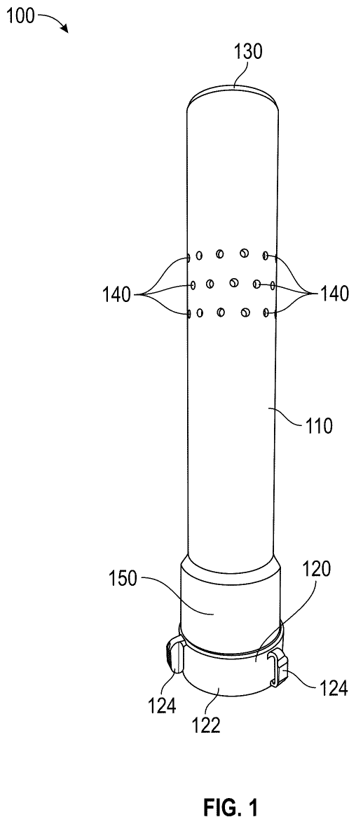

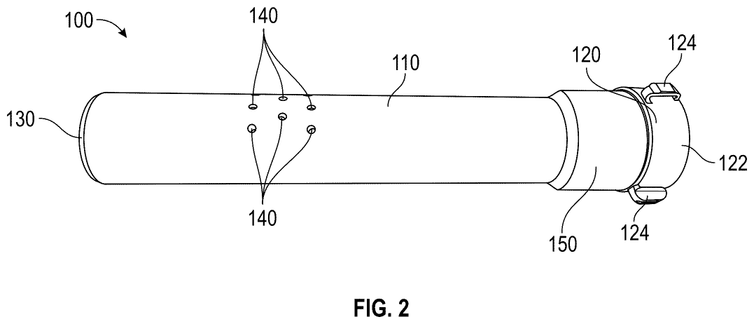

As shown in FIGS. 1 and 2, a water curtain nozzle 100 generally comprises a cylindrical body 110 having an open end 120 configured for attachment to a fire hose and a closed end 130 opposite the open end 120. The cylindrical body 110 extends between the open end 120 and the closed end 130. Each of a plurality of apertures 140 extends through the cylindrical body 110. The plurality of apertures 140 forms one or more rows radially arranged generally halfway around the circumference of the cylindrical body 110 and oriented to expel fluid from the cylindrical body 110 perpendicular to a longitudinal axis of the cylindrical body 110. When pressurized fluid is expelled from the apertures 140, a generally semicircular curtain or wall of water is formed. In operation, the water curtain nozzle 100 may be placed between a burning structure and an adjacent structure to prevent the fire from spreading to the adjacent structure. In one embodiment, the plurality of apertures 140 forms three rows of apertures 140. The apertures 140 in each row may be staggered relative to the apertures 140 in the other rows such that a more continuous water curtain is created when pressurized fluid is expelled from the apertures 140.

The open end 120 may include a fire hose connection 122 having a first end, a second end, and a plurality of tabs 124 to facilitate grasping and rotating the water curtain nozzle 100 during attachment or detachment to a hose. The first end of fire hose connection 122 may comprise a threaded connector configured to securely attach a fire hose to the water curtain nozzle 100. The second end of fire hose connection 122 may be welded or threaded onto the cylindrical body 110. The fire hose connection 122 may be hard-coat anodized to meet NFPA standards. Fire hose connection 122 may comprise a standard 1.5 inch NH hose couplers. In operation, fire hose connection 122 prevents the water curtain nozzle 100 from disconnecting from the fire hose as high pressure fluid moves between connected elements. In one embodiment, fire hose connection 122 may be machined from 6061 extruded aluminum. In other embodiments, fire hose connection 122 may be formed from another suitable material without departing from the scope of the disclosure.

The closed end 130 of the water curtain nozzle 100 may be hemi-spherical, flat, or any other suitable shape without departing from the scope of the disclosure.

The cylindrical body 110 may have a constant wall thickness extending from the open end 120 to the closed end 130 and uniform sizes for the apertures 140. The cylindrical body 110 may feature an enlargement 150 comprising a section of the cylindrical body 110 near the open end 120 that has an enlarged diameter. The cylindrical body 110 may be integral with the closed end 130 or the closed end 130 may be coupled to the cylindrical body 110. As shown, the closed end 130 is integral to the cylindrical body 110 providing a unitary structure and smooth continuous interior surface. The size may be scaled up or down to produce a desired flow or fit a desired hose size.

In one arrangement, the water curtain nozzle 100 may be formed from aluminum. In other arrangements, the water curtain nozzle 100 may comprise another metal or another suitable material without departing from the scope of the disclosure. The water curtain nozzle 100 may be anodized or hard coat anodized to meet NFPA standards.

In use, fluid is pumped through the hose into the water curtain nozzle 100 through the open end 120. The fluid is expelled through the apertures 140 producing a large diameter roughly semicircular dispersal pattern. The water curtain nozzle 100 may be placed between a burning structure and an adjacent structure, and when fluid is expelled through the apertures 140 the large diameter roughly semicircular dispersal of fluid creates a water curtain that prevents fire from spreading from the burning structure to the adjacent structure.

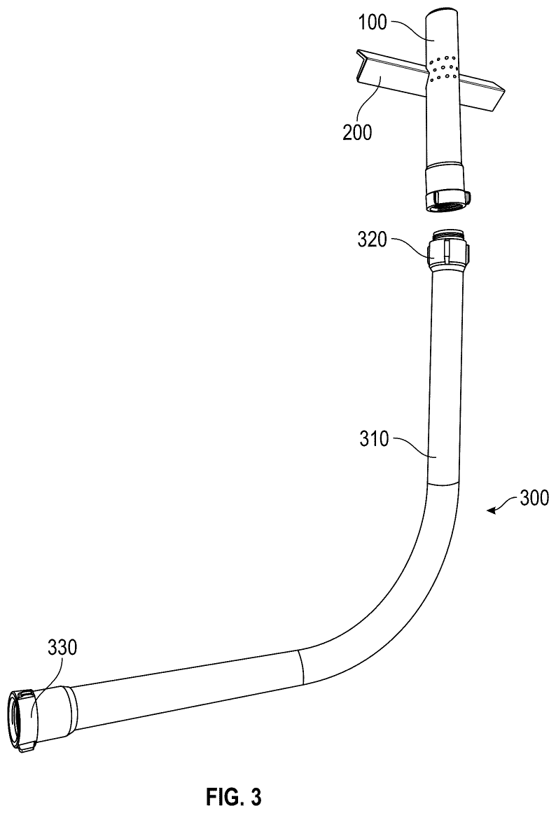

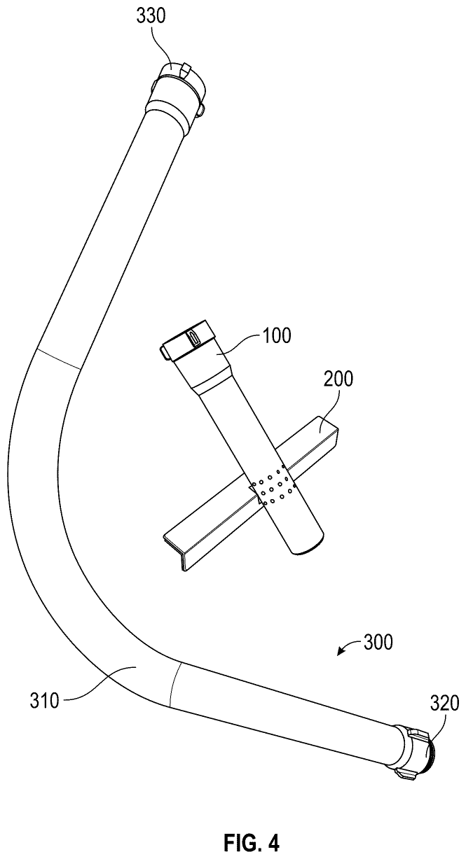

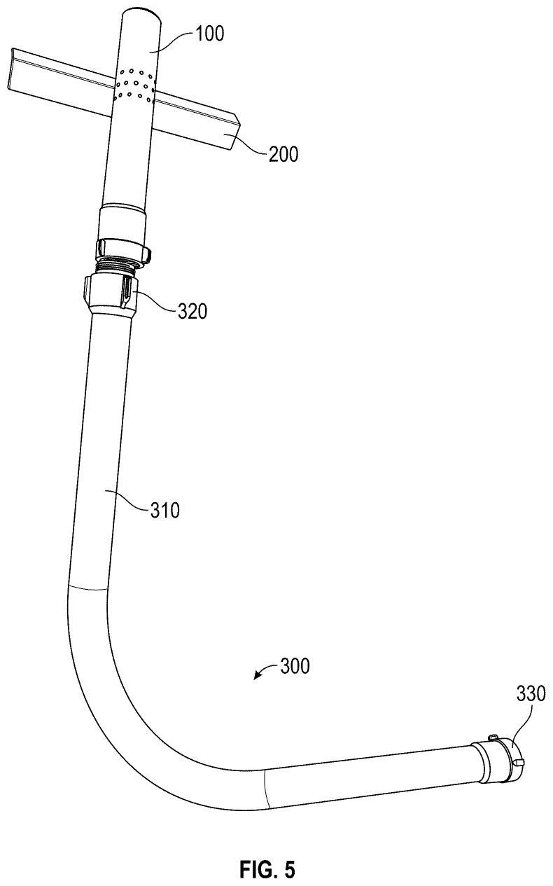

As shown in FIGS. 3-5 a base 200 may be used in conjunction with the water curtain nozzle 100. The base 200 provides additional stability for the water curtain nozzle 100 when the water curtain nozzle 100 is in use. In one embodiment, base 200 may comprise a length of angle aluminum or another suitable material having two generally rectangular surfaces that meet generally perpendicular to each other. The water curtain nozzle 100 may be placed in a notch formed at the approximate center of the base 200. The notch may be a generally semicircular cutout disposed at the intersection of the two generally perpendicular rectangular surfaces of the base 200. With a generally semicircular notch, the notch of base 200 matches and accepts the shape and size of the cylindrical body 110 of the water curtain nozzle 100 and prevents movement of the water curtain nozzle 100 when it is in use; however, other notch shapes may be used without departing from the scope of the disclosure. Base 200 is of suitable length for preventing the water curtain nozzle 100 from rotating or otherwise moving when the water curtain nozzle 100 is in use. The base 200 may be anodized or hard coat anodized to meet NFPA standards.

As shown in FIGS. 3-5, an extension 300 may be used in conjunction with the water curtain nozzle 100. The extension 300 provides additional reach and stability for the water curtain nozzle 100. The extension 300 may comprise an angled tube 310 having a first end 320 and a second end 330 that is opposite to the first end 320. In one embodiment, angled tube 310 comprises a length of tubing that has been bent at the approximate center of angled tube 310. The first end 320 of the extension 300 connects to the open end 120 of the water curtain nozzle 100. The second end 330 of the extension 300 attaches to a fire hose. In addition to providing additional reach and stability for the water curtain nozzle 100, the bend in the angled tube 310 allows for precise positioning of the water curtain nozzle 100. Without extension 300, the water curtain nozzle 100 would tend to orient in generally the same direction as the attached firehose; however, extension 300 allows the water curtain nozzle 100 to be placed and stably remain in any position regardless of the position of the attached firehose.

The water curtain nozzle 100 has many benefits and advantages including, but not limited to reduced fire and heat damage to neighboring structures. These and other benefits and advantages of the water curtain nozzle 100 are apparent from the specification and claims.

### REFERENCE NUMERALS

100—Water curtain nozzle or nozzle
110—Cylindrical body
120—Open end
122—Fire hose connection
124—Tabs
130—Closed end
140—Apertures
150—Enlargement
200—Base
300—Extension
310—Angled tube of extension 300
320—First end of extension 300
330—Second end of extension 300

What is claimed:

1. A water curtain nozzle comprising:
a cylindrical body having an open end configured for attachment to a fire hose and a closed end opposite the open end, the cylindrical body extending between the open end and the closed end; and
one or more rows of apertures extending through the cylindrical body, said one or more rows of apertures disposed generally along half of a circumference of the cylindrical body, and said one or more rows of apertures being oriented to expel fluid from the cylindrical body perpendicular to a longitudinal axis of the cylindrical body.

2. The water curtain nozzle of claim 1 wherein the cylindrical body has a uniform constant wall thickness.

3. The water curtain nozzle of claim 1 wherein the apertures are uniform in diameter.

4. The water curtain nozzle of claim 1 wherein the closed end is integral to the cylindrical body.

5. The water curtain nozzle of claim 4 wherein said cylindrical body and closed end have a continuous smooth interior surface.

6. A water curtain nozzle comprising:
a cylindrical body having an open end configured for attachment to a fire hose and a closed end opposite the open end, the cylindrical body extending between the open end and the closed end;
one or more rows of apertures extending through the cylindrical body, said one or more rows of apertures disposed generally along half of a perimeter of the cylindrical body, and said one or more rows of apertures being oriented to expel fluid from the cylindrical body perpendicular to a longitudinal axis of the cylindrical body;
wherein the cylindrical body has uniform constant wall thickness;
wherein the apertures are uniform in diameter;
wherein the closed end is integral to the cylindrical body; and
wherein said cylindrical body and closed end have a continuous smooth interior surface.

7. A water curtain nozzle comprising:
a body;
the body having a length extending from a first end to a second end;
the body having a circumference;
the body having one or more holes halfway around the circumference;
wherein the first end of the body is configured to attach to a water source;
wherein the second end of the body is closed such that when water is pumped into the body, the water is expelled through the one or more holes creating a wall of water in a semicircle shape.

8. The water curtain nozzle of claim 7 wherein the body has a uniform constant wall thickness.

9. The water curtain nozzle of claim 7 wherein the holes are uniform in diameter.

10. The water curtain nozzle of claim 7 wherein the second end is integral to the body.

11. The water curtain nozzle of claim 10 wherein the body and second end have a continuous smooth interior surface.

12. The water curtain nozzle of claim 7 wherein the first end of the body is configured to attach to an extension hose.

13. The water curtain nozzle of claim 7 wherein the body is configured to attach to a base.

14. The water curtain nozzle of claim 7 wherein the body is configured to attach to a base;
the base comprising a first surface and a second surface and a length;
wherein the first surface and the second surface meet at an angle;
wherein a semicircular groove is located on the angle along the length of the base;
wherein the water curtain nozzle is configured to fit within the semicircular groove.
